(19) United States
(12) Patent Application Publication
(10) Pub. No.: US 2011/0245398 A1
(43) Pub. Date: Oct. 6, 2011

(54) METHOD FOR PRODUCING CONJUGATED DIENE POLYMER COMPOSITION

(75) Inventors: Hisakatsu HAMA, Chiba (JP); Mana ITO, Tokyo (JP)

(73) Assignee: SUMITOMO CHEMICAL COMPANY, LIMITED, Tokyo (JP)

(21) Appl. No.: 13/053,919

(22) Filed: Mar. 22, 2011

(30) Foreign Application Priority Data
Mar. 31, 2010 (JP) 2010-081673
Nov. 15, 2010 (JP) 2010-254543

(51) Int. Cl. C08L 9/00; C08K 3/20; C08K 3/36

(52) U.S. Cl. 524/424; 524/571; 524/572

(57) ABSTRACT

A method for producing a conjugated diene polymer composition is provided that comprises the step of kneading a conjugated diene polymer, silica and a silane coupling agent using a kneading machine in the presence of 1 to 50 parts by weight of water and/or carbon dioxide relative to 100 parts by weight of the conjugated diene polymer.

### BACKGROUND OF THE INVENTION

1. Field of the Invention

The present invention relates to a method for producing a conjugated diene polymer composition.

2. Description of Related Art

In recent years, with the growing concern over environmental problems the demand for good fuel economy for automobiles has been becoming stronger, and there is also a demand for excellent fuel economy for polymer compositions used for automobile tires. As a polymer composition for automobile tires, a polymer composition formed by mixing a silica and a silane coupling agent with the conjugated diene polymer such as polybutadiene or a butadiene-styrene copolymer is used.

For example, JP-A-61-60738 (JP-A denotes a Japanese unexamined patent application publication) and JP-A-3-252431 describe a conjugated diene polymer composition produced by kneading a styrene-butadiene copolymer, a silica, and a silane coupling agent. Moreover, for example, JP-A-2005-290355 and JP-A-2005-344039 describe a conjugated diene polymer composition produced by kneading a styrene-butadiene copolymer modified by a modifying agent having a functional group, a silica, and a silane coupling agent.

### SUMMARY OF THE INVENTION

However, the above-mentioned conventional polymer compositions employing a conjugated diene polymer are not always satisfactory in terms of fuel economy.

Under such circumstances, an object of the present invention is to provide a method for producing a conjugated diene polymer composition that can give the polymer composition having excellent fuel economy.

That is, the present invention relates to a method for producing a conjugated diene polymer composition, comprising a step of kneading a conjugated diene polymer, a silica and a silane coupling agent using a kneading machine in the presence of 1 to 50 parts by weight of water and/or carbon dioxide relative to 100 parts by weight of the conjugated diene polymer.

### DETAILED DESCRIPTION OF THE INVENTION

A conjugated diene polymer is polymer having conjugated diene-based constitutional unit (conjugated diene unit). Examples of the conjugated diene include 1,3-butadiene, isoprene, 1,3-pentadiene, 2,3-dimethyl-1,3-butadiene, and 1,3-hexadiene, and one or more types thereof may be used. Among them, 1,3-butadiene and isoprene are preferable.

In addition to a conjugated diene unit, the conjugated diene polymer may have a constitutional unit based on another monomer. Examples of the other monomers include aromatic vinyl compounds, vinylnitrile and unsaturated carboxylic acid ester. The aromatic vinyl compounds include styrene, α-methylstyrene, vinyltoluene, vinylnaphthalene, divinylbenzene, trivinylbenzene and divinylnaphthalene. The vinylnitrile includes acrylonitrile, and the unsaturated carboxylic acid ester includes methyl acrylate, ethyl acrylate, methyl methacrylate and ethyl methacrylate.

Examples of the conjugated diene polymers include poly(1,3-butadiene), polyisoprene, 1,3-butadiene-isoprene copolymer, 1,3-butadiene-styrene copolymer, isoprene-styrene copolymer, acrylonitrile-butadiene copolymer, isoprene-isobutylene copolymer, ethylene-propylene-diene copolymer, etc.

In order to increase strength, the conjugated diene polymer preferably contains an aromatic vinyl compound-based constituent unit (aromatic vinyl compound unit). The content of the aromatic vinyl compound unit, relative to 100 wt % of the total amount of the conjugated diene unit and the aromatic vinyl compound unit, is preferably not less than 10 wt % (the content of the conjugated diene unit being not more than 90 wt %), and more preferably not less than 15 wt % (the content of the conjugated diene unit being not more than 85 wt %). Furthermore, in order to improve fuel economy, the content of the aromatic vinyl compound unit is preferably not more than 50 wt % (the content of the conjugated diene unit being not less than 50 wt %), and more preferably not more than 45 wt % (the content of the conjugated diene unit being not less than 55 wt %).

As the conjugated diene polymer, conjugated diene polymers having at least one kind of functional group are used favorably. The functional groups include nitrogen atom-containing functional groups and silicon atom-containing functional groups. Preferable are silicon atom-containing functional groups. The nitrogen atom-containing functional groups include a substituted or unsubstituted amino group, amide group, ═NCO—, imino group, imidazolyl group, nitrile group, pyridyl group, etc. The silicon atom-containing functional groups include a hydroxysilyl group, an alkoxysilyl group, a halogenated silyl group, a hydrocarbylsilyloxy group, etc. The nitrogen atom-containing functional groups and the silicon atom-containing functional groups may be functional groups containing a nitrogen atom and a silicon atom, and such functional groups include an aminosilyl group, a trialkylsilylamino group, etc.

The alkoxysilyl group means the group represented by Formula (1) below.

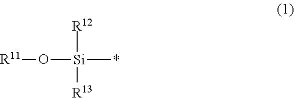

wherein R¹¹ represents an alkyl group, R¹² and R¹³ represent a monovalent substituent, and * represents a bonding position.

In Formula (1), R¹¹ represents an alkyl group, and the examples of the alkyl groups include a methyl group, an ethyl group, a n-propyl group, an isopropyl group, a n-butyl group, a sec-butyl group, a tert-butyl group, etc. R¹¹ is preferably an alkyl group having 1 to 12 carbon atoms, more preferably an alkyl group having 1 to 6 carbon atoms, yet more preferably an alkyl group having 1 to 4 carbon atoms, and particularly preferably a methyl group or an ethyl group.

R¹² and R¹³ represent a monovalent substituent, and R¹² and R¹³ may be bonded to form a ring. Preferably R¹² and R¹³ each independently is an alkoxy group, a hydrocarbyl group or a halogen atom. As the alkoxy group, an alkoxy group having 1 to 6 carbon atoms is preferable, an alkoxy group having 1 to 4 carbon atoms is more preferable, and a methoxy group or an ethoxy group is yet more preferable. As the hydrocarbyl group, an alkyl group or an aryl group is exemplified, of which a hydrocarbyl group having 1 to 10 carbon atoms is preferable. The alkyl group includes a methyl group, an ethyl group, a n-propyl group, an isopropyl group, a n-butyl group, a sec-butyl group, a tert-butyl group, etc. The aryl group includes a phenyl group, etc. As the hydrocarbyl group, an alkyl group is preferable, and an alkyl group having 1 to 4 carbon atoms is more preferable. As the halogen atom, a fluorine atom, a chlorine atom, a bromine atom and an iodine atom are exemplified, of which a chlorine atom is preferable.

The hydrocarbylsilyloxy group means a group represented by Formula (2) below.

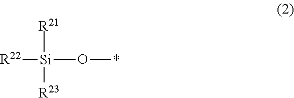

wherein R²¹, R²² and R²³ represent a hydrocarbyl group, and * represents a bonding position.

In Formula (2), R²¹, R²² and R²³ each independently represents a hydrocarbyl group, and the hydrocarbyl group includes an alkyl group, an aryl group, etc. The alkyl group includes a methyl group, an ethyl group, a n-propyl group, an isopropyl group, a n-butyl group, a sec-butyl group, a tert-butyl group, etc. The aryl group includes a phenyl group, etc. As the hydrocarbyl group, an alkyl group is preferable, and an alkyl group having 1 to 4 carbon atoms is more preferable. Two groups selected from R²¹, R²² and R²³ may be bonded to form a ring.

The aminosilyl group means a group represented by Formula (3) below.

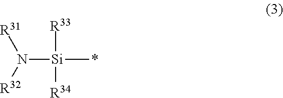

wherein R³¹ and R³² represent an alkyl group, R³³ and R³⁴ represent a monovalent substituent, and * represents a bonding position.

In Formula (3), R³¹ and R³² each independently represents an alkyl group, and the alkyl group includes a methyl group, an ethyl group, a n-propyl group, an isopropyl group, a n-butyl group, a sec-butyl group, a tert-butyl group, etc. R¹¹ is preferably an alkyl group having 1 to 12 carbon atoms, more preferably an alkyl group having 1 to 6 carbon atoms, yet more preferably an alkyl group having 1 to 4 carbon atoms, and particularly preferably a methyl group or an ethyl group. R³¹ and R³² may be bonded to form a ring.

In Formula (3), R³³ and R³⁴ each independently represents a monovalent substituent, and preferable modes are the same as those of R¹¹ and R¹² in Formula (1).

The trialkylsilyl amino group means a group represented by Formula (4) below.

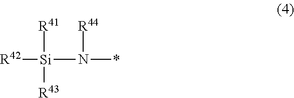

wherein R⁴¹, R⁴² and R⁴³ each represents an alkyl group, R⁴⁴ represents a hydrogen atom or a monovalent substituent, and * represents a bonding position.

In Formula (4), R⁴¹, R⁴² and R⁴³ each independently represents an alkyl group, and the alkyl group includes a methyl group, an ethyl group, a n-propyl group, an isopropyl group, a n-butyl group, a sec-butyl group, a tert-butyl group, etc. R⁴¹, R⁴² and R⁴³ each is preferably an alkyl group having 1 to 12 carbon atoms, more preferably an alkyl group having 1 to 6 carbon atoms, yet more preferably an alkyl group having 1 to 4 carbon atoms, and particularly preferably a methyl group or an ethyl group. Two groups selected from the group consisting of R⁴¹, R⁴² and R⁴³ may be bonded to form a ring.

R⁴⁴ represents a hydrogen atom or a monovalent substituent, and is preferably a hydrogen atom or a hydrocarbyl group. The hydrocarbyl group includes an alkyl group, an aryl group, etc. The alkyl group includes a methyl group, an ethyl group, a n-propyl group, an isopropyl group, a n-butyl group, a sec-butyl group, a tert-butyl group, etc. The aryl group includes a phenyl group, etc. As the hydrocarbyl group, an alkyl group is preferable, and an alkyl group having 1 to 4 carbon atoms is more preferable. R⁴⁴ is preferably a hydrogen atom.

In the present specification, the hydrocarbyl group represents a hydrocarbon residue.

As the method for producing a conjugated diene polymer having a functional group, a known method can be employed. For example, method (a), method (b) and method (c) below are cited.

(a) A method of polymerizing a monomer containing a conjugated diene in the presence of a polymerization catalyst (for example, an organic alkali metal compound, an organic peroxide), and the conjugated diene polymer thus obtained is reacted with a modifying agent having a nitrogen atom-containing functional group, a modifying agent having a silicon atom-containing functional group, or a modifying agent having a nitrogen atom-containing functional group and a silicon atom-containing functional group.

(b) A method of polymerizing a monomer having a nitrogen atom-containing functional group and/or a silicon atom-containing functional group and, a monomer containing conjugated diene in the presence of a polymerization catalyst (for example, an organic alkali metal compound, an organic peroxide).

(c) A method of polymerizing a monomer containing a conjugated diene in the presence of an organic alkali metal compound having a nitrogen atom-containing functional group and/or a silicon atom-containing functional group.

Moreover, methods obtained by combining these methods are also cited, such as a combined method of (a) and (b), and a combined method of (a) and (c).

Examples of the modifying agents having a nitrogen atom-containing functional group in the method (a) include compounds having an amino group and a carbonyl group. Examples of the compounds having an amino group and a carbonyl group include 4-aminoacetophenone such as 4-N,N-dimethylaminoacetophenone, 4-N-methyl-N-ethylaminoacetophenone, 4-N,N-diethylaminoacetophenone, 4′-(imidazole-1-yl)acetophenone and 4-pyrazolylacetophenone; bis(dihydrocarbylaminoalkyl)ketone such as 1,7-bis(methylethylamino)-4-heptanone and 1,3-bis(diphenylamino)-2-propanone; 4-(dihydrocarbylamino)benzophenone such as 4-N,N-dimethylaminobenzophenone, 4-N,N-di-t-butylaminobenzophenone and 4-N,N-diphenylaminobenzophenone; 4,4′-bis(dihydrocarbylamino)benzophenone such as 4,4′-bis(dimethylamino)benzophenone, 4,4′-bis(diethylamino)benzophenone and 4,4′-bis(diphenylamino)benzophenone; 2-dihydrocarbylaminoethyl acrylate such as 2-dimethylaminoethyl acrylate and 2-diethylaminoethyl acrylate; 3-dihydrocarbylaminopropyl acrylate such as 3-dimethylaminopropyl acrylate; 2-dihydrocarbylaminoethyl methacrylate such as 2-dimethylaminoethyl methacrylate and 2-diethylaminoethyl methacrylate; and 3-dihydrocarbylaminopropyl methacrylate such as 3-dimethylaminopropyl methacrylate.

Moreover, as the modifying agent having a nitrogen atom-containing functional group in the method (a), compounds having ═NCO— are also cited. Examples of the compounds having ═NCO— include N-dihydrocarbylformamide such as N,N-dimethylformamide and N,N-diethylformamide; N,N-dihydrocarbylacetamide such as N,N-dimethylacetamide and N,N-diethylacetamide; N-hydrocarbyl-β-propiolactam such as N-methyl-β-propiolactam and N-phenyl-β-propiolactam; N-hydrocarbyl-2-pyrrolidone such as N-methyl-2-pyrrolidone, N-vinyl-2-pyrrolidone, N-phenyl-2-pyrrolidone, N-tert-butyl-2-pyrrolidone and N-methyl-5-methyl-2-pyrrolidone; N-hydrocarbyl-2-piperidone such as N-methyl-2-piperidone, N-vinyl-2-piperidone and N-phenyl-2-piperidone; N-hydrocarbyl-ε-caprolactam such as N-methyl-ε-caprolactam and N-phenyl-ε-caprolactam, N-hydrocarbyl-ω-laurilolactam such as N-methyl-ω-laurilolactam and N-vinyl-ω-laurilolactam; 1,3-dihydrocarbyl-2-imidazolidinone such as 1,3-dimethyl-2-imidazolidinone, 1,3-diethyl-2-imidazolidinone, 1,3-divinyl-2-imidazolidinone and 1-methyl-3-ethyl-2-imidazolidinone; N,N-dihydrocarbylacrylamide such as N,N-dimethylacrylamide, N,N-diethylacrylamide and N-methyl-N-ethylacrylamide; and N,N-dihydrocarbylmethacrylamide such as N,N-dimethylmethacrylamide, N,N-diethylmethacrylamide and N-methyl-N-ethylmethacrylamide.

Furthermore, as the modifying agent having a nitrogen atom-containing functional group in the method (a), compounds having an amide group are cited. Examples of the compounds having an amide group include N,N-dihydrocarbylaminoethylacrylamide such as N,N-dimethylaminoethylacrylamide and N,N-diethylaminoethylacrylamide; N,N-dihydrocarbylaminopropylacrylamide such as N,N-dimethylaminopropylacrylamide and N,N-diethylaminopropylacrylamide; N,N-dihydrocarbylaminobutylacrylamide such as N,N-dimethylaminobutylacrylamide and N,N-diethylaminobutylacrylamide; N,N-dihydrocarbylaminoethylmethacrylamide such as N,N-dimethylaminoethylmethacrylamide and N,N-diethylaminoethylmethacrylamide; N,N-dihydrocarbylaminopropylmethacrylamide such as N,N-dimethylaminopropylmethacrylamide and N,N-diethylaminopropylmethacrylamide; and N,N-dihydrocarbylaminobutylmethacrylamide such as N,N-dimethylaminobutylmethacrylamide and N,N-diethylaminobutylmethacrylamide. Of these, N,N-dihydrocarbylaminopropylacrylamide is preferable.

Examples of the modifying agents having a silicon atom-containing functional group in the method (a) include compounds having an alkoxysilyl group. Examples of the compounds having an alkoxysilyl group include tetraalkoxysilane such as tetramethoxysilane, tetraethoxysilane and tetra-n-propoxysilane; trialkoxyhydrocarbylsilane such as methyltrimethoxysilane, methyltriethoxysilane, ethyltrimethoxysilane and phenyltrimethoxysilane; trialkoxyhalosilane such as trimethoxychlorosilane, triethoxychlorosilane and tri-n-propoxychlorosilane; dialkoxydihydrocarbylsilane such as dimethoxydimethylsilane, diethoxydimethylsilane and dimethoxydiethylsilane; dialkoxydihalosilane such as dimethoxydichlorosilane, diethoxydichlorosilane and di-n-propoxydichlorosilane; monoalkoxytrihydrocarbylsilane such as methoxytrimethylsilane; monoalkoxytrihalosilane such as methoxytrichlorosilane and ethoxytrichlorosilane; (glycidoxyalkyl)alkoxysilane compounds such as 2-glycidoxyethyltrimethoxysilane, 2-glycidoxyethyltriethoxysilane, (2-glycidoxyethyl)methyldimethoxysilane, 3-glycidoxypropyltrimethoxysilane, 3-glycidoxypropyltriethoxysilane and (3-glycidoxypropyl)methyldimethoxysilane; (3,4-epoxycyclohexyl)alkylalkoxysilane compounds such as 2-(3,4-epoxycyclohexyl)ethyltrimethoxysilane, 2-(3,4-epoxycyclohexyl)ethyltriethoxysilane and 2-(3,4-epoxycyclohexyl)ethyl(methyl)dimethoxysilane; alkoxysilylalkyl succinic anhydride such as 3-trimethoxysilyipropyl succinic anhydride and 3-triethoxysilylpropyl succinic anhydride; and (methacryloyloxyalkyl)alkoxysilane compounds such as 3-methacryloyloxypropyltrimethoxysilane and 3-methacryloyloxypropyltriethoxysilane.

Examples of the modifying agents having a silicon atom-containing functional group and a nitrogen atom-containing functional group in the method (a) include compounds having an alkoxysilyl group and an amino group, and compounds having an alkoxysilyl group and ═NCO—.

Examples of the compounds having an alkoxysilyl group and an amino group include [(dialkylamino)alkyl]alkoxysilane compounds such as 3-dimethylaminopropyltriethoxysilane, 3-dimethylaminopropyltrimethoxysilane, 3-diethylaminopropyltriethoxysilane, 3-diethylaminopropyltrimethoxysilane, 3-dimethylaminopropylmethyldiethoxysilane, 2-dimethylaminoethyltriethoxysilane and 2-dimethylaminoethyltrimethoxysilane; cyclic aminoalkylalkoxysilane compounds such as hexamethyleneiminomethyltrimethoxysilane, 3-hexamethyleneiminopropyltriethoxysilane, N-(3-triethoxysilylpropyl)-4,5-dihydroimidazole and N-(3-trimethoxysilylpropyl)-4,5-imidazole; [di(tetrahydrofuranyl)amino]alkylalkoxysilane compounds such as 3-[di(tetrahydrofuranyl)amino]propyltrimethoxysilane and 3-[di(tetrahydrofuranyl)amino]propyltriethoxysilane; and N,N-bis(trialkylsilyl)aminoalkylalkoxysilane compounds such as N,N-bis(trimethylsilyl)aminopropylmethyldimethoxysilane and N,N-bis(trimethylsilyl)aminopropylmethyldiethoxysilane. Of these, [(dialkylamino)alkyl]alkoxysilane compounds are preferable.

Examples of the compounds having an alkoxysilyl group and ═NCO— include tris[(alkoxysilyl)alkyl]isocyanurate compounds such as tris[3-(trimethoxysilyl)propyl]isocyanurate, tris[3-(triethoxysilyl)propyl]isocyanurate, tris[3-(tripropoxysilyl)propyl]isocyanurate and tris[3-(tributoxysilyl)propyl]isocyanurate.

In addition to above-mentioned compounds, examples of modifying agents having a silicon atom-containing functional group and a nitrogen atom-containing functional group include N,N-bis(trialkylsilyl)aminopropylacrylamide such as N,N-bis(trimethylsilyl)aminopropylacrylamide; (isocyanatoalkyl)alkoxysilane compounds such as 3-isocyanatopropyltrimethoxysilane and 3-isocyanatopropyltriethoxysilane; (cyanoalkyl)alkoxysilane compounds such as 2-cyanoethyltrimethoxysilane, 2-cyanoethyltriethoxysilane, 2-cyanoethyldimethoxymethylsilane, 2-cyanoethylmethoxydimethylsilane, 2-cyanoethyldimethoxyethylsilane and 2-cyanoethylmethoxydiethylsilane; and N-alkylidene-3-(alkoxysilyl)-1-propaneamine compounds such as N-(1,3-dimethylbutylidene)-3-(triethoxysilyl)-1-propaneamine, N-(1-methylethylidene)-3-(triethoxysilyl)-1-propaneamine, N-(1,3-dimethylbutylidene)-3-(trimethoxysilyl)-1-propaneamine and N-(1-methylethylidene)-3-(trimethoxysilyl)-1-propaneamine.

Examples of the monomers having a nitrogen atom-containing functional group and/or a silicon atom-containing functional group in the method (b) include amino group-containing aromatic vinyl compounds, alkoxy group-containing vinylsilane compounds, alkoxysilyl group-containing conjugated diene compounds and amino group-containing vinylsilane compounds. Of these, alkoxy group-containing vinylsilane compounds and amino group-containing vinylsilane compounds are preferable, and amino group-containing vinylsilane compounds are more preferable.

Examples of the amino group-containing aromatic vinyl compounds include N,N-dialkylaminoalkylstyrene such as 4-N,N-dimethylaminostyrene, 3-N,N-dimethylaminostyrene, 4-N,N-diethylaminostyrene, 3-N,N-diethylaminostyrene, 4-N,N-dimethylaminomethylstyrene, 3-N,N-dimethylaminomethylstyrene, 4-N,N-diethylaminomethylstyrene, 3-N,N-diethylaminomethylstyrene, 4-N,N-dimethylaminoethylstyrene, 3-N,N-dimethylaminoethylstyrene, 4-N,N-diethylaminoethylstyrene and 3-N,N-diethylaminoethylstyrene; cyclic aminoalkylstyrene such as 4-pyrrolidinylstyrene, 3-pyrrolidinylstyrene, 4-piperidinylstyrene, 3-piperidinylstyrene, 4-pyrrolidinylmethylstyrene, 3-pyrrolidinylmethylstyrene, 4-piperidinylmethylstyrene, 3-piperidinylmethylstyrene, 4-pyrrolidinylethylstyrene, 3-pyrrolidinylethylstyrene, 4-piperidinylethylstyrene and 3-piperidinylethylstyrene; 1-(N,N-dialkylaminophenyl)-1-phenylethylene such as 1-(4-N,N-dimethylaminophenyl)-1-phenylethylene, 1-(3-N,N-dimethylaminophenyl)-1-phenylethylene, 1-(4-N,N-diethylaminophenyl)-1-phenylethylene and 1-(3-N,N-diethylaminophenyl)-1-phenylethylene; and vinylpyridine such as 2-vinylpyridine and 4-vinylpyridine.

Moreover, as the amino group-containing aromatic vinyl compounds, trialkylsilylamino group-containing aromatic vinyl compounds are cited. Examples of the trialkylsilylamino group-containing aromatic vinyl compounds include N,N-bis(trialkylsilyl)aminoalkylstyrene such as 4-N,N-bis(trimethylsilyl)aminostyrene, 3-N,N-bis(trimethylsilyl)aminostyrene, 4-N,N-bis(trimethylsilyl)aminomethylstyrene, 3-N,N-bis(trimethylsilyl)aminomethylstyrene, 4-N,N-bis(trimethylsilyl)aminoethylstyrene and 3-N,N-bis(trimethylsilyl)aminoethylstyrene.

Examples of the alkoxy group-containing vinylsilane compounds include trialkoxyvinylsilane such as trimethoxyvinylsilane, triethoxyvinylsilane and tripropoxyvinylsilane; dialkoxyalkylvinylsilane such as methyldimethoxyvinylsilane and methyldiethoxyvinylsilane; dialkoxyarylvinylsilane such as di(tert-pentoxy)phenylvinylsilane and di(tert-butoxy)phenylvinylsilane; monoalkoxydialkylvinylsilane such as dimethylmethoxyvinylsilane; monoalkoxydiarylvinylsilane such as tert-butoxydiphenylvinylsilane and tert-pentoxydiphenylvinylsilane; monoalkoxyalkylarylvinylsilane such as tert-butoxymethylphenylvinylsilane and tert-butoxyethylphenylvinylsilane; and substituted alkoxyvinylsilane compounds such as tris(β-methoxyethoxy)vinylsilane. Of these, monoalkoxydiarylvinylsilane is preferable.

Examples of the alkoxysilyl group-containing conjugated diene compounds include 2-trimethoxysilyl-1,3-butadiene, 2-triethoxysilyl-1,3-butadiene, 2-tripropoxysilyl-1,3-butadiene, 2-tributoxysilyl-1,3-butadiene, 2-triphenoxysilyl-1,3-butadiene, etc.

The amino group-containing vinylsilane compounds include aminosilyl group-containing vinyl compounds. Examples of the aminosilyl group-containing vinyl compounds include bis(dialkylamino)alkylvinylsilane such as bis(dimethylamino)methylvinylsilane, bis(diethylamino)methylvinylsilane, bis(di(n-propyl)amino)methylvinylsilane, bis(di(n-butyl)amino)methylvinylsilane, etc.

Examples of the organic alkali metal compounds having a nitrogen atom-containing functional group and/or a silicon atom-containing functional group in the method (c) include lithium amide compounds, aminohydrocarbyl lithium compounds and hydrocarbylsilyloxyhydrocarbyl lithium compounds. Of these, hydrocarbylsilyloxyhydrocarbyl lithium compounds are preferable.

Examples of the lithium amide compounds include lithium hexamethyleneimide, lithium pyrrolidide, lithium piperidide, lithium heptamethyleneimide, lithium dodecamethyleneimide, lithium dimethylamide, lithium diethylamide, lithium dibutylamide, lithium dipropylamide, lithium diheptylamide, lithium dihexylamide, lithium dioctylamide, lithium di-2-ethylhexylamide, lithium didecanamide, lithium-N-methylpiperazide, lithium ethylpropylamide, lithium ethylbutylamide, lithium methylbutylamide, lithium ethylbenzylamide and lithium methylphenethylamide.

Examples of the aminohydrocarbyl lithium compounds include 3-(N,N-dimethylamino)-1-propyl lithium, 3-(N,N-diethylamino)-1-propyl lithium, 3-(N,N-dipropylamino)-1-propyl lithium, 3-(N,N-dibutylamino)-1-propyl lithium, 3-morpholino-1-propyl lithium and 3-imidazolyl-1-propyl lithium. Moreover, such compounds may also be employed that are obtained by reacting these aminohydrocarbyl lithium compounds with a monomer such as butadiene, isoprene, styrene or the like in 1 to 10 equivalents of the monomer relative to 1 equivalent of the compound.

Examples of the hydrocarbylsilyloxyhydrocarbyl lithium compounds include trialkylsilyloxyalkyl lithium such as 3-(tert-butyldimethylsilyloxy)-1-propyl lithium, 4-(tert-butyldimethylsilyloxy)-1-butyl lithium, 5-(tert-butyldimethylsilyloxy)-1-pentyl lithium, 6-(tert-butyldimethylsilyloxy)-1-hexyl lithium, 8-(tert-butyldimethylsilyloxy)-1-octyl lithium and 3-(triisopropylsilyloxy)-1-propyl lithium; and alkyldiarylsilyloxyalkyl lithium such as 3-(tert-butyldiphenylsilyloxy)-1-propyl lithium and 6-(tert-butyldiphenylsilyloxy)-1-hexyl lithium. Of these, trialkylsilyloxyalkyl lithium is preferable. Moreover, such compounds may also be employed that are obtained by reacting these hydrocarbylsilyloxyhydrocarbyl lithium compounds with a monomer such as butadiene, isoprene, styrene or the like in 1 to 10 equivalents of the monomer relative to 1 equivalent of the compound.

As the conjugated diene polymer having a functional group, conjugated diene polymers having a nitrogen atom-containing functional group and/or a silicon atom-containing functional group are preferable, conjugated diene polymers having a silicon atom-containing functional group are more preferable, and conjugated diene polymers having a nitrogen atom-containing functional group and a silicon atom-containing functional group (in the case of a functional group containing a nitrogen atom and a silicon atom, a conjugated diene polymer having the functional group alone is acceptable, too) are yet more preferable.

In order to increase strength, the Mooney viscosity (ML₁₊₄) of the conjugated diene polymer is preferably not less than 10, and more preferably not less than 20. Furthermore, in order to improve processability, it is preferably not more than 200, and more preferably not more than 150. The Mooney viscosity (ML₁₊₄) is measured at 100° C. in accordance with JIS K6300 (1994).

In order to improve fuel economy, the vinyl bond content (vinyl content) of the conjugated diene polymer, with the content of the conjugated diene unit as 100 mol %, is preferably not more than 80 mol %, and more preferably not more than 70 mol %. Furthermore, in order to improve grip properties, it is preferably not less than 10 mol %, more preferably not less than 15 mol %, yet more preferably not less than 20 mol %, and particularly preferably not less than 40 mol %. The vinyl bond content may be obtained by IR spectroscopy from the absorption intensity at around 910 cm⁻¹, which is an absorption peak of a vinyl group.

From the viewpoint of fuel economy, the molecular weight distribution of the conjugated diene polymer used in the present invention is preferably 1 to 5, and more preferably 1 to 2. The molecular weight distribution is obtained by measuring number-average molecular weight (Mn) and weight-average molecular weight (Mw) by a gel permeation chromatograph (GPC) method, and dividing Mw by Mn.

Examples of the silica include dry silica (anhydrous silicic acid), wet silica (hydrated silicic acid), colloidal silica, precipitated silica, calcium silicate, and aluminum silicate. One or more types thereof may be used. The BET specific surface area of the silica is preferably 50 to 250 m²/g. The BET specific surface area is measured in accordance with ASTM D1993-03. As a commercial product, product names VN3, AQ, ER, and RS-150 manufactured by Tosoh Silica Corporation, product names Zeosil 1115MP and 1165MP manufactured by Rhodia, etc. may be used.

From the viewpoint of enhancing the abrasion resistance and strength, relative to 100 parts by weight of the conjugated diene polymer, the amount of the silica combined is preferably not less than 1 part by weight, more preferably not less than 10 parts by weight, yet more preferably not less than 20 parts by weight, and particularly preferably not less than 30 parts by weight. Furthermore, from the viewpoint of enhancing the reinforcement property, the amount is preferably not more than 200 parts by weight, more preferably not more than 120 parts by weight, and yet more preferably not more than 100 parts by weight.

Examples of the silane coupling agent include vinyltrichlorosilane, vinyltriethoxysilane, vinyltris(β-methoxyethoxy)silane, β-(3,4-epoxycyclohexyl)ethyltrimethoxysilane, γ-glycidoxypropyltrimethoxysilane, γ-methacryloxypropyltrimethoxysilane, N-(β-aminoethyl)-γ-aminopropyltrimethoxysilane, N-(β-aminoethyl)-γ-aminopropylmethyldimethoxysilane, N-phenyl-γ-aminopropyltrimethoxysilane, γ-chloropropyltrimethoxysilane, γ-mercaptopropyltrimethoxysilane, γ-aminopropyltriethoxysilane, bis(3-(triethoxysilyl)propyl)disulfide, bis(3-(triethoxysilyl)propyl)tetrasulfide, γ-trimethoxysilylpropyldimethylthiocarbamyl tetrasulfide, and γ-trimethoxysilylpropylbenzothiazyl tetrasulfide. One or more types thereof may be used. As a commercial product, product names Si69 and Si75 manufactured by Degussa GmbH, etc. may be used.

In order to enhance the fuel economy, relative to 100 parts by weight of the conjugated diene polymer, the amount of the silane coupling agent combined is preferably not less than 1 part by weight, and more preferably not less than 5 parts by weight. In order to enhance the economical efficiency, the amount is preferably not more than 20 parts by weight, and more preferably not more than 10 parts by weight.

In the method of the present invention, the conjugated diene polymer, the silica and the silane coupling agent are kneaded in the presence of water and/or carbon dioxide. Relative to 100 parts by weight of the conjugated diene polymer, the total amount of water and carbon dioxide to be present in the kneading is 1 to 50 parts by weight. In order to enhance the fuel economy, the amount is preferably not less than 5 parts by weight, and more preferably not less than 10 parts by weight. In order to enhance the fuel economy or economical efficiency, the amount is preferably not more than 30 parts by weight, and more preferably not more than 20 parts by weight.

In the method of the present invention, preferably the conjugated diene polymer, the silica and the silane coupling agent are kneaded in the presence of water and carbon dioxide. In the supply of water and carbon dioxide into the kneading machine, water and carbon dioxide are preferably supplied as a mixed solution of water and carbon dioxide, that is, as carbonate water. The carbonate water has preferably a pH of 4 to 6.

As the kneading machine for use in kneading the conjugated diene polymer, the silica and the silane coupling agent in the presence of water and/or carbon dioxide, a known kneading machine can be employed. Examples thereof include extruders such as a single screw extruder and a twin screw extruder; closed type kneading machines such as a kneader, a Banbury mixer and an internal mixer; and roll kneading machines. An extruder or a closed type kneading machine is preferable.

The kneading temperature is preferably 50 to 200° C., and more preferably 80 to 190° C. The kneading time is preferably 30 sec to 30 min, and more preferably 1 min to 30 min.

When the conjugated diene polymer, the silica and the silane coupling agent are kneaded in the presence of water and/or carbon dioxide, another polymer component or an additive may be combined. Moreover, another polymer component or an additive may be combined to a conjugated diene polymer composition prepared by kneading the conjugated diene polymer, the silica and the silane coupling agent in the presence of water and/or carbon dioxide.

Examples of another polymer component include natural rubber, an ethylene-propylene copolymer, and an ethylene-octene copolymer. One or more types thereof may be used.

As the additive, a known additive may be used, and examples thereof include a vulcanizing agent such as sulfur and organic peroxide; a vulcanization accelerator such as a thiazole-based vulcanization accelerator, a thiuram-based vulcanization accelerator, a sulfenamide-based vulcanization accelerator, or a guanidine-based vulcanization accelerator; a vulcanization activator such as stearic acid or zinc oxide; an organic peroxide; a filler such as carbon black, calcium carbonate, talc, alumina, clay, aluminum hydroxide, or mica; an extender oil; a processing aid; an antioxidant; and a lubricant.

The sulfur includes powder sulfur, precipitated sulfur, colloidal sulfur, insoluble sulfur and highly dispersed sulfur. Powder sulfur and insoluble sulfur are preferable.

Examples of the organic peroxides include dicumylperoxide, 2,5-dimethyl-2,5-di(tert-butylperoxy)hexane, 2,5-dimethyl-2,5-di(benzoylperoxy)hexane, 2,5-dimethyl-2,5-(tert-butylperoxy)hexyne-3, di-tert-butylperoxide, di-tert-butylperoxide-3,3,5-trimethylcyclohexane and tert-butylhydroperoxide.

In the case where a vulcanizing agent is combined, relative to 100 parts by weight of the conjugated diene polymer, the amount of the vulcanizing agent combined is preferably 0.1 to 15 parts by weight, more preferably 0.3 to 10 parts by weight, and yet more preferably 0.5 to 5 parts by weight.

Examples of the vulcanization accelerator include thiazole-based vulcanization accelerators such as 2-mercaptobenzothiazole, dibenzothiazyl disulfide, and N-cyclohexyl-2-benzothiazylsulfenamide; thiuram-based vulcanization accelerators such as tetramethylthiuram monosulfide and tetramethylthiuram disulfide; sulfenamide-based vulcanization accelerators such as N-cyclohexyl-2-benzothiazolesulfenamide, N-t-butyl-2-benzothiazolesulfenamide, N-oxyethylene-2-benzothiazolesulfenamide, N-oxyethylene-2-benzothiazolesulfenamide, and N,N′-diisopropyl-2-benzothiazolesulfenamide; and guanidine-based vulcanization accelerators such as diphenylguanidine, diorthotolylguanidine and orthotolylbiguanidine.

In the case where a vulcanizing accelerator is combined, relative to 100 parts by weight of the conjugated diene polymer, the amount of the vulcanizing accelerator combined is preferably 0.1 to 5 parts by weight, more preferably 0.2 to 3 parts by weight.

Examples of the carbon black include furnace black, acetylene black, thermal black, channel black, and graphite. With regard to the carbon black, channel carbon black such as EPC, MPC, or CC; furnace carbon black such as SAF, ISAF, HAF, MAF, FEF, SRF, GPF, APF, FF, CF, SCF, or ECF; thermal carbon black such as FT or MT; and acetylene carbon black can be cited as examples. One or more types thereof may be used.

The nitrogen adsorption specific surface area (N₂SA) of the carbon black is preferably 5 to 200 m²/g, and the dibutyl phthalate (DBP) absorption of the carbon black is preferably 5 to 300 mL/100 g. The nitrogen adsorption specific surface area is measured in accordance with ASTM D4820-93, and the DBP absorption is measured in accordance with ASTM D2414-93. As a commercial product, product names SEAST 6, SEAST 7HM, and SEAST KH manufactured by Tokai Carbon Co., Ltd., product names CK 3 and Special Black 4A manufactured by Degussa, Inc., etc. may be used.

In the case where the carbon black is combined, the weight ratio of the amount of the silica combined and the amount of the carbon black combined (amount of silica combined/amount of carbon black combined) is preferably 30/70 to 95/5.

Examples of the extender oil include an aromatic mineral oil (viscosity-gravity constant (V.G.C. value) 0.900 to 1.049), a naphthenic mineral oil (V.G.C. value 0.850 to 0.899), and a paraffinic mineral oil (V.G.C. value 0.790 to 0.849). The polycyclic aromatic content of the extender oil is preferably less than 3% by weight, and more preferably less than 1% by weight. The polycyclic aromatic content is measured in accordance with British Institute of Petroleum method 346/92. Furthermore, the aromatic compound content (CA) of the extender oil is preferably not less than 20% by weight. One or more types thereof may be used.

With regard to kneading conditions, when an additive other than a vulcanizing agent or a vulcanization accelerator, or another polymer component is combined with the conjugated polymer composition, the kneading temperature is usually 50° C. to 200° C. and preferably 80° C. to 190° C., and the kneading time is usually 30 sec to 30 min and preferably 1 min to 30 min. When a vulcanizing agent or a vulcanization accelerator is combined, the kneading temperature is preferably not more than 100° C., and more preferably room temperature to 80° C. A composition in which a vulcanizing agent or a vulcanization accelerator is combined is usually used after carrying out a vulcanization treatment such as press vulcanization. The vulcanization temperature is preferably 120° C. to 200° C., and more preferably 140° C. to 180° C.

The conjugated diene polymer composition obtained by the method of the present invention has excellent fuel economy. The grip properties are also good.

The conjugated diene polymer composition obtained by the method of the present invention is used for tires, shoe soles, flooring materials, vibration-proofing materials, etc., and is particularly suitably used for tires.

In accordance with the present invention, there can be provided a method for producing a conjugated diene polymer composition that can give the polymer composition having excellent fuel economy.

### Example

The present invention is explained below by reference to Examples.

Physical properties were evaluated by the following methods.

### 1. Mooney Viscosity (ML₁₊₄)

The Mooney viscosity of a polymer was measured at 100° C. in accordance with JIS K6300 (1994).

### 2. Vinyl Content (Units: mol %)

The vinyl content of a polymer was determined by IR spectroscopy from the absorption intensity at around 910 cm⁻¹, which is an absorption peak of a vinyl group.

### 3. Styrene Unit Content (Units: wt %)

The styrene unit content of a polymer was determined from refractive index in accordance with JIS K6383 (1995).

### 4. Rebound Resilience

It was measured using a Lupke type rebound resilience tester at 60° C. in accordance with JIS K6255. The higher the value, the better the fuel economy.

### 5. Grip Properties

The loss tangent (tan δ (0° C.)) at 0° C. of the vulcanized sheet was measured using a viscoelastometer VR-7110 (manufactured by Ueshima Seisakusho Co., Ltd.) under conditions of a strain of 0.25% and a frequency of 10 Hz. The greater this value, the better the grip properties.

The conjugated diene polymer, the silica and the silane coupling agent below were used in Examples and Comparative Examples.

### (a) Conjugated Diene Polymer

SBR1: an oil extended styrene-butadiene copolymer (modified by tris[3-(trimethoxysilyl)propyl]isocyanurate). Styrene unit content: 25 wt %. Vinyl content: 55 mol %. Mooney viscosity (ML₁₊₄ (100° C.)): 52. Relative to 100 parts by weight of the styrene-butadiene copolymer, 18 parts by weight of an extender oil is contained.

SBR2: a styrene-butadiene copolymer, (copolymerized with dialkylaminovinylsilane(bis(diethylamino)methylvinylsilane), modified by N,N-dimethylaminopropylacrylamide). Styrene unit content: 25 wt %. Vinyl content: 55 mol %. Mooney viscosity (ML₁₊₄ (100° C.)): 52.

SBR3: a styrene-butadiene copolymer (modified by aminohydrocarbyloxysilane(3-diethylaminopropyltrimethoxysilane)). Styrene unit content: 25 wt %. Vinyl content: 57 mol %. Mooney viscosity (ML₁₊₄ (100° C.)): 54.

SBR4: a styrene-butadiene copolymer (modified by N,N-dimethylaminopropylacrylamide). Styrene unit content: 22 wt %. Vinyl content: 58 mol %. Mooney viscosity (ML₁₊₄ (100° C.)): 77.

SBR5: a styrene-butadiene copolymer (3-(tert-butyldimethylsilyloxy)-1-propyl lithium was used as an initiator). Styrene unit content: 24 wt %. Vinyl content: 56 mol %. Mooney viscosity (ML₁₊₄ (100° C.)): 43.

SBR6: a styrene-butadiene copolymer (modified by tetraethoxysilane). Styrene unit content: 25 wt %. Vinyl content: 56 mol %. Mooney viscosity (ML₁₊₄ (100° C.)): 48.

SBR7: a styrene-butadiene copolymer (copolymerized with tert-butoxydiphenylvinylsilane). Styrene unit content: 23 wt %. Vinyl content: 58 mol %. Mooney viscosity (ML₁₊₄ (100° C.)): 53.

### (b) Silica

Trade name: ULTRASIL VN3-G, manufactured by Degussa GmbH

### (c) Silane Coupling Agent

Trade name: Si69, manufactured by Degussa GmbH

### Example 1

118 parts by weight of SBR1, 10 parts by weight of water, 78.4 parts by weight of a silica (trade name: ULTRASIL VN3-G, manufactured by Degussa GmbH), 6.4 parts by weight of a silane coupling agent (trade name: Si69, manufactured by Degussa GmbH), 6.4 parts by weight of a carbon black (trade name: DIABLACK N339, manufactured by Mitsubishi Chemical Corporation), 29.6 parts by weight of an extender oil (trade name: NC-140, manufactured by Nippon Oil Corporation), 1.5 parts by weight of an antioxidant (trade name: Antigen 3C, manufactured by Sumitomo Chemical Co., Ltd.), 2 parts by weight of stearic acid, 1.5 parts by weight of a wax (trade name: Sunnoc N, manufactured by Ouchi Shinko Chemical Industrial Co., Ltd.) were kneaded with a Labo Plastomill temperature-controlled at 70° C. for about 5 min. The polymer composition taken out was at about 120° C.

The polymer composition thus obtained was kneaded with 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), and 1.4 parts by weight sulfur with rolls temperature-controlled at 50° C., to thereby prepare a polymer composition. The polymer composition thus obtained was formed into a sheet with rolls, and the sheet was heated and vulcanized at 160° C. for 45 min, to thereby prepare a vulcanized sheet. The results of the evaluation of the physical properties of the vulcanized sheet are given in Table 1.

### Example 2

The procedure in Example 1 was repeated except that 10 parts by weight of water was replaced by 10 parts by weight of dry ice. The results of the evaluation of the physical properties of the vulcanized sheet are given in Table 1.

### Example 3

The procedure in Example 1 was repeated except that 10 parts by weight of dry ice was used in addition to 10 parts by weight of water. The results of the evaluation of the physical properties of the vulcanized sheet are given in Table 1.

### Example 4

The procedure in Example 1 was repeated except that 10 parts by weight of water was replaced by 10 parts by weight of a carbonate water (730 mg of carbon dioxide was dissolved in 100 ml of the carbonate water. pH was 4 to 5). The results of the evaluation of the physical properties of the vulcanized sheet are given in Table 1.

### Comparative Example 1

The procedure in Example 1 was repeated except that 10 parts by weight of water was not used. The results of the evaluation of the physical properties of the vulcanized sheet are given in Table 1.

TABLE 1

| | | | | | Comp. |
|---|---|---|---|---|---|
| | Ex. 1 | Ex. 2 | Ex. 3 | Ex. 4 | Ex. 1 |
| Fuel economy | 58.7 | 56.1 | 59.2 | 58.9 | 55.9 |
| rebound resilience | | | | | |
| (60° C.) (—) | | | | | |
| Grip properties | 0.352 | 0.358 | 0.344 | 0.349 | 0.359 |
| tanδ (0° C.) (—) | | | | | |

### Example 5

100 parts by weight of SBR2, 10 parts by weight of water, 78.4 parts by weight of a silica (trade name: ULTRASIL VN3-G, manufactured by Degussa GmbH), 6.4 parts by weight of a silane coupling agent (trade name: Si69, manufactured by Degussa GmbH), 6.4 parts by weight of a carbon black (trade name: DIABLACK N339, manufactured by Mitsubishi Chemical Corporation), 47.6 parts by weight of an extender oil (trade name: NC-140, manufactured by Nippon Oil Corporation), 1.5 parts by weight of an antioxidant (trade name: Antigen 3C, manufactured by Sumitomo Chemical Co., Ltd.), 2 parts by weight of stearic acid, 1.5 parts by weight of a wax (trade name: Sunnoc N, manufactured by Ouchi Shinko Chemical Industrial Co., Ltd.) were kneaded with a Labo Plastomill temperature-controlled at 70° C. for about 5 min. The polymer composition taken out was at about 120° C.

The polymer composition thus obtained was kneaded with 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), and 1.4 parts by weight of sulfur with rolls temperature-controlled at 50° C., to thereby prepare a polymer composition. The polymer composition thus obtained was formed into a sheet with rolls, and the sheet was heated and vulcanized at 160° C. for 45 min, to thereby prepare a vulcanized sheet. The results of the evaluation of the physical properties of the vulcanized sheet are given in Table 2.

### Example 6

The procedure in Example 5 was repeated except that 10 parts by weight of water was replaced by 10 parts by weight of dry ice. The results of the evaluation of the physical properties of the vulcanized sheet are given in Table 2.

### Example 7

The procedure in Example 5 was repeated except that 10 parts by weight of dry ice was used in addition to 10 parts by weight of water. The results of the evaluation of the physical properties of the vulcanized sheet are given in Table 2.

### Example 8

The procedure in Example 5 was repeated except that 10 parts by weight of water was replaced by 10 parts by weight of a carbonate water (730 mg of carbon dioxide was dissolved in 100 ml of the carbonate water. pH was 4 to 5). The results of the evaluation of the physical properties of the vulcanized sheet are given in Table 2.

### Comparative Example 2

The procedure in Example 5 was repeated except that 10 parts by weight of water was not used. The results of the evaluation of the physical properties of the vulcanized sheet are given in Table 2.

TABLE 2

| | | | | | Comp. |
|---|---|---|---|---|---|
| | Ex. 5 | Ex. 6 | Ex. 7 | Ex. 8 | Ex. 2 |
| Fuel economy | 64.2 | 63.5 | 66.5 | 65.1 | 62.8 |
| rebound resilience | | | | | |
| (60° C.) (—) | | | | | |
| Grip properties | 0.848 | 0.851 | 0.936 | 0.943 | 0.846 |
| tanδ (0° C.) (—) | | | | | |

### Example 9

100 parts by weight of SBR3, 10 parts by weight of water, 10 parts by weight of dry ice, 78.4 parts by weight of a silica (trade name: ULTRASIL VN3-G, manufactured by Degussa GmbH), 6.4 parts by weight of a silane coupling agent (trade name: Si69, manufactured by Degussa GmbH), 6.4 parts by weight of a carbon black (trade name: DIABLACK N339, manufactured by Mitsubishi Chemical Corporation), 47.6 parts by weight of an extender oil (trade name: NC-140, manufactured by Nippon Oil Corporation), 1.5 parts by weight of an antioxidant (trade name: Antigen 3C, manufactured by Sumitomo Chemical Co., Ltd.), 2 parts by weight of stearic acid, 1.5 parts by weight of a wax (trade name: Sunnoc N, manufactured by Ouchi Shinko Chemical Industrial Co., Ltd.) were kneaded with a Labo Plastomill temperature-controlled at 70° C. for about 5 min. The polymer composition taken out was at about 120° C.

The polymer composition thus obtained was kneaded with 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), and 1.4 parts by weight of sulfur with rolls temperature-controlled at 50° C., to thereby prepare a polymer composition. The polymer composition thus obtained was formed into a sheet with rolls, and the sheet was heated and vulcanized at 160° C. for 45 min, to thereby prepare a vulcanized sheet. The results of the evaluation of the physical properties of the vulcanized sheet are given in Table 3.

### Example 10

The procedure in Example 9 was repeated except that 10 parts by weight of a carbonate water (730 mg of carbon dioxide was dissolved in 100 ml of the carbonate water. pH was 4 to 5) was used in place of 10 parts by weight of water and 10 parts by weight of dry ice. The results of the evaluation of the physical properties of the vulcanized sheet are given in Table 3.

### Comparative Example 3

The procedure in Example 9 was repeated except that 10 parts by weight of water and 10 parts by weight of dry ice were not used. The results of the evaluation of the physical properties of the vulcanized sheet are given in Table 3.

TABLE 3

| | | | Comp. |
|---|---|---|---|
| | Ex. 9 | Ex. 10 | Ex. 3 |
| Fuel economy | 61.8 | 62.1 | 61.1 |
| rebound resilience | | | |
| (60° C.) (—) | | | |
| Grip properties | 0.744 | 0.764 | 0.844 |
| tanδ (0° C.) (—) | | | |

### Example 11

100 parts by weight of SBR4, 10 parts by weight of water, 10 parts by weight of dry ice, 78.4 parts by weight of a silica (trade name: ULTRASIL VN3-G, manufactured by Degussa GmbH), 6.4 parts by weight of a silane coupling agent (trade name: Si69, manufactured by Degussa GmbH), 6.4 parts by weight of a carbon black (trade name: DIABLACK N339, manufactured by Mitsubishi Chemical Corporation), 47.6 parts by weight of an extender oil (trade name: NC-140, manufactured by Nippon Oil Corporation), 1.5 parts by weight of an antioxidant (trade name: Antigen 3C, manufactured by Sumitomo Chemical Co., Ltd.), 2 parts by weight of stearic acid, 1.5 parts by weight of a wax (trade name: Sunnoc N, manufactured by Ouchi Shinko Chemical Industrial Co., Ltd.) were kneaded with a Labo Plastomill temperature-controlled at 70° C. for about 5 min. The polymer composition taken out was at about 120° C.

The polymer composition thus obtained was kneaded with 2 parts by weight of zinc oxide, 1 part by weight of a vulcanization accelerator (trade name: Soxinol CZ, manufactured by Sumitomo Chemical Co., Ltd.), 1 part by weight a vulcanization accelerator (trade name: Soxinol D, manufactured by Sumitomo Chemical Co., Ltd.), and 1.4 parts by weight of sulfur with rolls temperature-controlled at 50° C., to thereby prepare a polymer composition. The polymer composition thus obtained was formed into a sheet with rolls, and the sheet was heated and vulcanized at 160° C. for 45 min, to thereby prepare a vulcanized sheet. The results of the evaluation of the physical properties of the vulcanized sheet are given in Table 4.

### Example 12

The procedure in Example 11 was repeated except that 10 parts by weight of a carbonate water (730 mg of carbon dioxide was dissolved in 100 ml of the carbonate water. pH was 4 to 5.) was used in place of 10 parts by weight of water and 10 parts by weight of dry ice. The results of the evaluation of the physical properties of the vulcanized sheet are given in Table 4.

### Comparative Example 4

The procedure in Example 11 was repeated except that 10 parts by weight of water and 10 parts by weight of dry ice were not used. The results of the evaluation of the physical properties of the vulcanized sheet are given in Table 4.

TABLE 4

| | | | Comp. |
|---|---|---|---|
| | Ex. 11 | Ex. 12 | Ex. 4 |
| Fuel economy | 54.5 | 54.2 | 53.7 |
| rebound resilience | | | |
| (60° C.) (—) | | | |
| Grip properties | 0.516 | 0.504 | 0.502 |
| tanδ (0° C.) (—) | | | |

### Example 13

100 parts by weight of SBR5, 10 parts by weight of a carbonate water (730 mg of carbon dioxide was dissolved in 100 ml of the carbonate water. pH was 4 to 5), 78.4 parts by weight of a silica (trade name: ULTRASIL VN3-G, manufactured by Degussa GmbH), 6.4 parts by weight of a silane coupling agent (trade name: Si69, manufactured by Degussa GmbH), 6.4 parts by weight of a carbon black (trade name: DIABLACK N339, manufactured by Mitsubishi Chemical Corporation), 47.6 parts by weight of an extender oil (trade name: NC-140, manufactured by Nippon Oil Corporation), 1.5 parts by weight of an antioxidant (trade name: Antigen 3C, manufactured by Sumitomo Chemical Co., Ltd.), 2 parts by weight of stearic acid, 1.5 parts by weight of a wax (trade name: Sunnoc N, manufactured by Ouchi Shinko Chemical Industrial Co., Ltd.) were kneaded with a Labo Plastomill temperature-controlled at 70° C. for about 5 min. The polymer composition taken out was at about 120° C.

The polymer composition thus obtained was kneaded with 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), and 1.4 parts by weight of sulfur with rolls temperature-controlled at 50° C., to thereby prepare a polymer composition. The polymer composition thus obtained was formed into a sheet with rolls, and the sheet was heated and vulcanized at 160° C. for 45 min, to thereby prepare a vulcanized sheet. The results of the evaluation of the physical properties of the vulcanized sheet are given in Table 5.

### Comparative Example 5

The procedure in Example 13 was repeated except that 10 parts by weight of the carbonate water was not used. The results of the evaluation of the physical properties of the vulcanized sheet are given in Table 5.

TABLE 5

| | | Comp. |
|---|---|---|
| | Ex. 13 | Ex. 5 |
| Fuel economy | 50.9 | 48.4 |
| rebound resilience | | |
| (60° C.) (—) | | |
| Grip properties | 0.524 | 0.486 |
| tanδ (0° C.) (—) | | |

### Example 14

100 parts by weight of SBR6, 10 parts by weight of a carbonate water (730 mg of carbon dioxide was dissolved in 100 ml of the carbonate water. pH was 4 to 5), 78.4 parts by weight of a silica (trade name: ULTRASIL VN3-G, manufactured by Degussa GmbH), 6.4 parts by weight of a silane coupling agent (trade name: Si69, manufactured by Degussa GmbH), 6.4 parts by weight of a carbon black (trade name: DIABLACK N339, manufactured by Mitsubishi Chemical Corporation), 47.6 parts by weight of an extender oil (trade name: NC-140, manufactured by Nippon Oil Corporation), 1.5 parts by weight of an antioxidant (trade name: Antigen 3C, manufactured by Sumitomo Chemical Co., Ltd.), 2 parts by weight of stearic acid, 1.5 parts by weight of a wax (trade name: Sunnoc N, manufactured by Ouchi Shinko Chemical Industrial Co., Ltd.) were kneaded with a Labo Plastomill temperature-controlled at 70° C. for about 5 min. The polymer composition taken out was at about 120° C.

The polymer composition thus obtained was kneaded with 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), and 1.4 parts by weight of sulfur with rolls temperature-controlled at 50° C., to thereby prepare a polymer composition. The polymer composition thus obtained was formed into a sheet with rolls, and the sheet was heated and vulcanized at 160° C. for 45 min, to thereby prepare a vulcanized sheet. The results of the evaluation of the physical properties of the vulcanized sheet are given in Table 6.

### Comparative Example 6

The procedure in Example 14 was repeated except that 10 parts by weight of the carbonate water was not used. The results of the evaluation of the physical properties of the vulcanized sheet are given in Table 6.

TABLE 6

| | | Comp. |
|---|---|---|
| | Ex. 14 | Ex. 6 |
| Fuel economy | 54.2 | 50.9 |
| rebound resilience | | |
| (60° C.) (—) | | |
| Grip properties | 0.544 | 0.501 |
| tanδ (0° C.) (—) | | |

### Example 15

100 parts by weight of SBR7, 10 parts by weight of a carbonate water (730 mg of carbon dioxide was dissolved in 100 ml of the carbonate water. pH was 4 to 5), 78.4 parts by weight of a silica (trade name: ULTRASIL VN3-G, manufactured by Degussa GmbH), 6.4 parts by weight of a silane coupling agent (trade name: Si69, manufactured by Degussa GmbH), 6.4 parts by weight of a carbon black (trade name: DIABLACK N339, manufactured by Mitsubishi Chemical Corporation), 47.6 parts by weight of an extender oil (trade name: NC-140, manufactured by Nippon Oil Corporation), 1.5 parts by weight of an antioxidant (trade name: Antigen 3C, manufactured by Sumitomo Chemical Co., Ltd.), 2 parts by weight of stearic acid, 1.5 parts by weight of a wax (trade name: Sunnoc N, manufactured by Ouchi Shinko Chemical Industrial Co., Ltd.) were kneaded with a Labo Plastomill temperature-controlled at 70° C. for about 5 min. The polymer composition taken out was at about 120° C.

The polymer composition thus obtained was kneaded with 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), and 1.4 parts by weight of sulfur with rolls temperature-controlled at 50° C., to thereby prepare a polymer composition. The polymer composition thus obtained was formed into a sheet with rolls, and the sheet was heated and vulcanized at 160° C. for 45 min, to thereby prepare a vulcanized sheet. The results of the evaluation of the physical properties of the vulcanized sheet are given in Table 7.

### Comparative Example 7

The procedure in Example 15 was repeated except that 10 parts by weight of the carbonate water was not used. The results of the evaluation of the physical properties of the vulcanized sheet are given in Table 7.

TABLE 7

| | | Comp. |
|---|---|---|
| | Ex. 15 | Ex. 7 |
| Fuel economy | 49.7 | 48.0 |
| rebound resilience | | |
| (60° C.) (—) | | |
| Grip properties | 0.492 | 0.458 |
| tanδ (0° C.) (—) | | |

What is claimed is:

1. A method for producing a conjugated diene polymer composition, comprising a step of kneading a conjugated diene polymer, a silica and a silane coupling agent using a kneading machine in the presence of 1 to 50 parts by weight of water and/or carbon dioxide relative to 100 parts by weight of the conjugated diene polymer.

2. The method according to claim 1, wherein 1 to 200 parts by weight of the silica and 1 to 20 parts by weight of the silane coupling agent are kneaded relative to 100 parts by weight of the conjugated diene polymer.

3. The method according to claim 1, wherein the kneading is carried out at a temperature of 50 to 200° C. for 30 sec to 30 min.

4. The method according to claim 1, wherein the conjugated diene polymer is a modified conjugated diene polymer having at least one kind of functional group.

5. The method according to claim 1, wherein the conjugated diene polymer is a modified conjugated diene polymer having a nitrogen atom-containing functional group and/or a silicon atom-containing functional group.

6. The method according to claim 1, wherein the conjugated diene polymer is a modified conjugated diene polymer having at least one kind of functional group selected from the group consisting of functional groups of a substituted or unsubstituted amino group, amide group, ═NCO—, alkoxysilyl group, hydrocarbylsilyloxy group and aminosilyl group.

7. The method according to claim 1, wherein the water and carbon dioxide are supplied as a carbonate water having a pH of 4 to 6 into the kneading machine.

8. The method according to claim 1, wherein the conjugated diene polymer has a constitutional unit based on an aromatic vinyl compound, in addition to a conjugated diene unit.
